(19) United States
(12) Patent Application Publication
(10) Pub. No.: US 2009/0064527 A1
(43) Pub. Date: Mar. 12, 2009

(54) Marking and measuring device

(76) Inventors: Glen Weavers, Kelowna (CA); Shayne Slatta, Kelowna (CA)

Correspondence Address: Shayne Slatta;c/o Beairsto Sabey, 201- 401 Glenmore Road, Kelowna, BC, V1V 1Z6, CA

(21) Appl. No.: 12/230,368

(22) Filed: Aug. 28, 2008

Related U.S. Application Data
(60) Provisional application No. 60/935,822, filed on Aug. 31, 2007.

(51) Int. Cl. G01B 3/12

(52) U.S. Cl. 33/775

(57) ABSTRACT

A marking and measuring device calibrated to measure and mark virtually any surface or object at regular predetermined intervals is provided. The marking and measuring device is comprised of a frame, a support member disposed on the frame configured to hold a container containing a marking substance, an actuator mounted with the frame wherein the actuator is in communication with an actuating means mounted with the frame such that the actuator may move between a discharging and non-discharging position when the actuating means sends a signal to the actuator, and at least two wheels rotatably coupled with the frame such that the at least two wheels rotate as the device is moved relative to a surface.

### PRIORITY CLAIM

This application claims the benefit to U.S. Provisional Patent Application No. 60/935,822 entitled MARKING AND MEASURING DEVICE filed on the 31 day of Aug., 2007, which is hereby incorporated by reference.

### FIELD OF THE INVENTION

The present invention relates generally to device for producing markers on a surface, and more particularly, it relates to a device that measures and marks recurring regular intervals on a surface.

### BACKGROUND OF THE INVENTION

In many industries, such as but not limited to the construction industry, it is frequently necessary to measure and mark a plurality of regular predetermined intervals on an object or surface of a constructional structure. Such plurality of markings may be used, for example, to indicate proper placement of construction elements such as but not limited to studs, rebar, attachment points, and other similar structural members. In another industry such as public works, the plurality of markings may be used to indicate boundaries such as on pavement to indicate traffic lanes.

Regardless of the industry or application, a substantial amount of time and effort is spent on measuring and marking various objects or surfaces at recurring regular or predetermined intervals. For example, in a construction environment, typically when a plurality of marks need to me made on a surface at regular recurring intervals, an operator must first perform the step of measuring the beginning and end points of each mark along the surface and then apply the marking substance on the surface at each of the previously measured beginning and end points preset by a surveying or measuring device. Thus, the operator must handle or operate a separate measurement device and a separate marking device. Unfortunately, any number of errors may occur in the typical measurement then mark process as previously described. For example, inaccurate measurement may occur, leading to inaccurate marking of the object or surface. Having to repeat the process of measuring and then marking is not only tedious but can also be a costly mistake. The time and labour expenditures associated with performing such time consuming two step operation is very large and may contribute to delays and inefficiencies in the construction process.

The use of a marking device for dispensing a marking substance such as paint is well known in the art. For example, there exists in the prior art spray paint aerosol cans disposed in various holders which enable users to operate the aerosol can to spray a mark while walking or standing erect. There also exists a number of surveying or measuring devices such as laser technology based measuring devices, tape measures, measuring wheels and other similar devices known in the art. Measuring devices that enable a user to manually operate a trigger to produce a mark are also available in the art.

Devices known for measuring and/or marking include U.S. Pat. No. 5,749,522 to Smrt which describes a marking device with distance measuring capability wherein the device discharges the contents of an aerosol container onto a surface and allows an operator to determine the distance the device traveled when moved relative to the surface.

U.S. Pat. No. 5,195,247 to Wilcox describes a construction layout marker having two marker wheels positioned in tandem on a wheel frame with a handle frame slanted upwardly from the front marker wheel. The two marker wheels are positioned a select distance apart and caused to rotate equally with a rotation equalizer to coordinate selective marking with both marker wheels.

U.S. patent application Ser. No. 09/902,681 to Waibel et al. describes a marking device for marking visual permanent markers on a surface, the device including a housing, a marking unit, a motorized drive for displacing the marking unit relative to the housing, a detector device for detecting a measurement signal and for generating a position signal upon deviation of the measurement signal from a marking signal and, a control circuit for controlling the drive and for actuating same in response to the position signal for displacing the marking unit relative to a reference housing position into a corrected marking position.

While the prior art devices provide for a means for measuring and/or marking a surface, such devices fail to address the problems associated with marking a surface with a plurality of marks at regular predetermined intervals. Accurately forming a plurality of measurement markings at predetermined intervals on an object or surface with conventional measurement devices and conventional marking devices is difficult. Accordingly, there is a need in the art for a marking and measuring device which overcomes the foregoing problems.

### SUMMARY

It is an object of the invention to provide a device that may be calibrated to measure and automatically mark virtually any surface or object at regular predetermined intervals.

It is a further object of the invention to provide a marking and measuring device that is ergonomically designed.

It is a further object of the invention to provide a portable and collapsible marking and measuring device configured to mark and measure virtually any surface.

In accordance with the invention, a marking and measuring device is provided, the marking and measuring device comprised of a frame having a handle, a support member disposed on the frame configured to hold a container containing a marking substance, an actuator mounted with the frame and in communication with an actuating means mounted with the frame, at least two wheels rotatably coupled with the frame such that the at least two wheels rotate relative to a surface, and a measurement mechanism mounted with the frame in communication with the actuating means wherein when the measurement mechanism sends a signal to the actuating means, the actuating means sends a signal to the actuator causing the marking substance to dispense from the container and onto the surface.

In an embodiment of the present invention, the marking and measuring device includes a controller adapted to measure and communicate such measurement with the actuating means to cause the actuator to displace between the discharging and non-discharging position.

In an embodiment of the present invention, the marking and measuring device is collapsible for portability and ease of transport.

In a further embodiment of the present invention, the measuring and marking device further comprises a stand pivotally coupled with the frame such that the stand may be displaced from a first closed position to a second open position such that the stand may support the measuring and marking device in an upright position on a surface when not in use.

### BRIEF DESCRIPTION OF THE DRAWINGS

These and other objects, benefits, or advantages of the invention are described in more detail and will be apparent after reviewing the drawings and description thereof wherein:

FIG. 1 is a perspective right side view of a preferred embodiment of the measuring and marking device;

FIG. 1a is a perspective left side view of the measuring and marking device as seen in FIG. 1;

FIG. 2 is a right side view of the device as seen in FIG. 1;

FIG. 3 is a left side view of the device as seen in FIG. 1;

FIG. 4 is a partial enlarged view of the actuating means of the device as seen in FIG. 1;

FIG. 5 is a partial enlarged view of the actuator as seen in FIG. 1;

FIG. 6 is a flow diagram illustrating the communication the actuating means and the actuator in an embodiment of the invention;

FIG. 7 is a side view of an alternate embodiment of the invention;

### DETAILED DESCRIPTION OF THE INVENTION

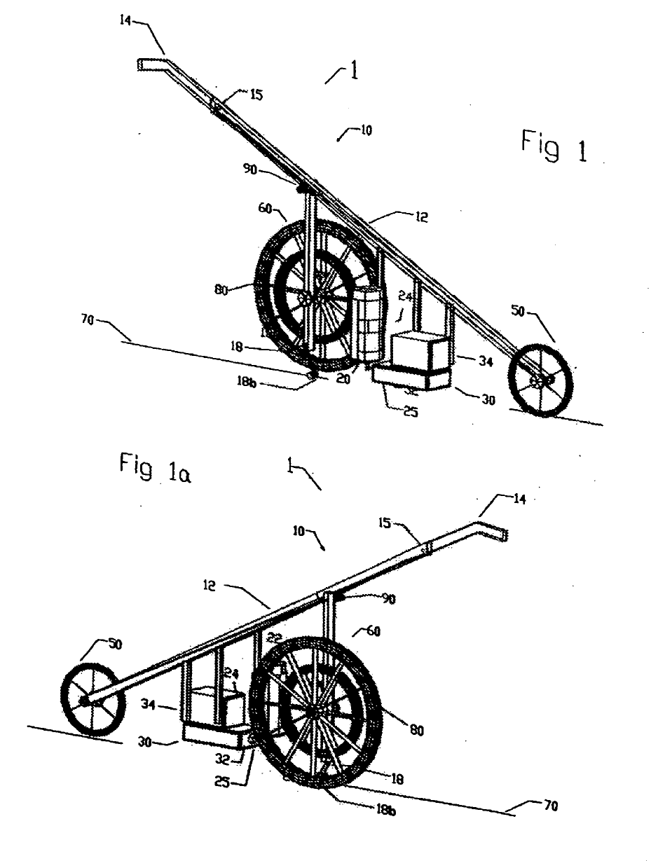

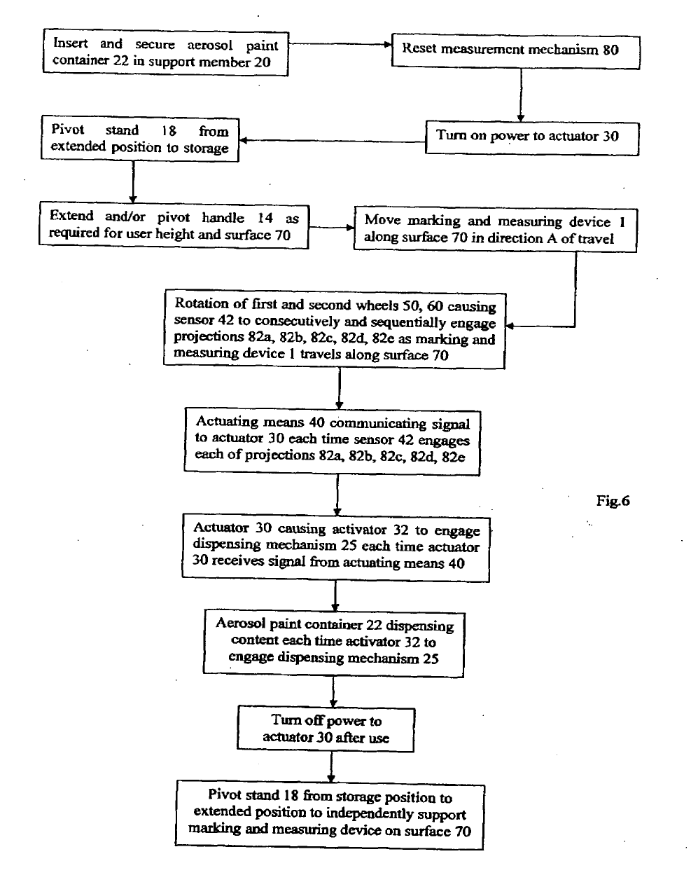

With reference to FIGS. 1 to 7, in accordance with an embodiment of the present invention, there is provided a marking and measuring device 1 comprising a frame 10, a support member 20 mounted with frame 10 configured to receive a container containing a marking substance, an actuator 30 mounted with frame 10 such that actuator 30 is in communication with an actuating means 40 mounted with frame 10, a first and a second wheel 50, 60 rotatably coupled with frame 10 such that first and second wheels 50, 60 rotate relative to a surface 70, and a measurement mechanism 80 mounted with frame 10 in communication with actuating means 40 wherein when measurement mechanism 80 sends a signal to actuating means 40, actuating means 40 sends a signal to actuator 30 causing marking substance to dispense from the container and onto surface 70.

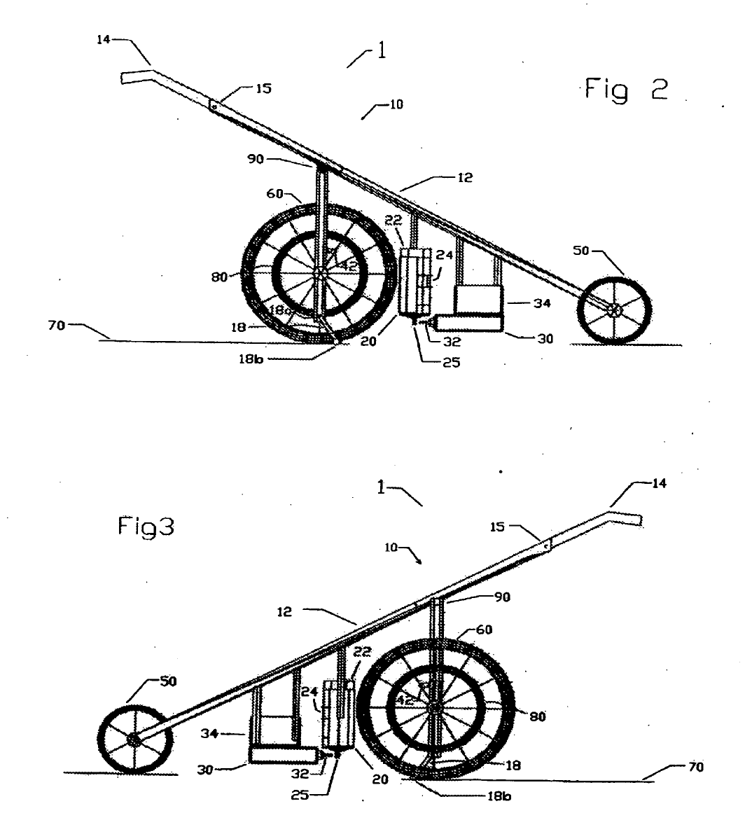

As best seen in FIGS. 1 to 3, frame 10 comprises of a body 12 and a handle 14. Frame 10 may be constructed of any lightweight durable material such as but limited to plastic, metal, aluminum or fiberglass. Preferably, frame 10 is made of stainless steel tubing. In an embodiment of the invention, body 12 and handle 14 may be a single unit. Preferably, handle 14 may be extendably attached with body 12 such that handle 14 may displace between an extended position and a collapsed position for compact portability. The user may use marking and measuring device 1 when handle 14 is in the collapsed position or in the extended position. Advantageously, handle 14 may be adjustably extended to adjust to the height of the user and to the surface 70 such that the user may easily mark and measure a plurality of surfaces such as but not limited to guiding marking and measuring device 1 vertically upwards along a wall. In an embodiment of the invention, handle 14 may be releasably secured in the extended position by any releasable locking mechanism 15 known in the art such as but not limited to lock pins or by compressible spring loaded lock rods such that when releasable locking mechanism 15 is disengaged, handle 14 may pivot about an axis relative to body 12. A conventional latch mechanism may be provided to secure handle 14 to body 12 when in the collapsed position. Preferably, handle 14 may swivel relative to body 12 and pivot about the axis by means known in the art such that handle 14 may be secured in a plurality of positions between a fully extended position and fully collapsed position generally in adjacent to and parallel with body 12. In the further alternative as seen in FIG. 2, handle 14 may be telescopic by means known in the art such that handle 14 may be disposed within body 12 when not in use and extended from body 12 when in use.

In an embodiment of the invention, a stand 18 may be operatively attached with frame 10 to provide support such that marking and measuring device 1 may independently be maintained in a substantially upright position without the assistance of another supporting surface. Preferably, stand 18 is a conventional kick stand assembly pivotably connected with frame 10 at a first end 18a such that stand 18 may displace between an extended position when in use and a storage position when not in use. When in the storage position, a spring mechanism maintains stand 18 in a position such that a second weight bearing end 18b of stand 18 is not in contact with surface 70. When in the extended position, stand 18 may be pivoted towards surface 70 such that second weight bearing end 18b engages surface 70 to support marking and measuring device 1 in a substantially upright position. Because of the orientation of first and second wheels 50, 60, as described in greater detail below, both of which engage surface 70, and the engagement of second weight bearing end 18b on surface 70, marking and measuring device 1 may be supported in a substantially upright position. When in such substantially upright position, potential damage to surface 70, any markings made by marking and measuring device 1 and/or marking and measuring device 1 itself may be minimized and the user may easily and conveniently take hold of marking and measuring device 1 to use. Thus, when the user wants to walk away from marking and measuring device 1, instead of finding an object or a surface to unstably lean marking and measuring device 1 against for support or bending over to rest the device on the ground, advantageously, the user may use his or her foot to pivot stand 18 from the storage position to the extended position to support marking and measuring device 1 in a substantially upright position, for example, on surface 70. When the user wants to return to marking and measuring device 1, the user may easily grasp handle 14 and use his or her foot to pivot stand 18 from the extended position to the storage position to resume work without having to bend down to pick up marking and measuring device 1.

Frame 10 provides support for the various components of marking and measuring device 1. Attached with frame 10 is support member 20 which is configured to receive and hold a container containing a marking substance such as but not limited to a conventional aerosol paint container 22 that is well known in the art. In an embodiment of the invention, support member 20 may comprise a generally cylindrical sleeve defining a receptacle sized and configured to receive aerosol paint container 22 within the sleeve. Alternatively, support member 20 may comprise at least one generally annular ring sized to receive aerosol paint container 22. Preferably, the circumference of support member 20 may be adjustable by way of a releaseable fastening means 24 such that the circumference of support member 20 may be enlarged when releasable fastening means 24 is released to facilitate ease of inserting aerosol paint container 22 into support member 20 and the circumference of support member 20 may be constricted when releasable fastening means 24 is fastened to position, secure, and retain aerosol paint container 22 in support member 20. Releasable fastening means 24 may be any conventional releasable fastening means such as but not limited to a screw, a clamp, or a spring release mechanism. In a preferred embodiment of the invention, support member 20 is configured to hold aerosol paint container 22 in an inverted position such that the contents of aerosol paint container 22 may be discharged on surface 70 when triggered, as described in greater detail below.

Actuator 30 is configured to effect the dispensing of the contents of aerosol paint container 22. Actuator 30 and support member 20 may be mounted with frame 10 such that when aerosol paint container 22 is received in support member 20, actuator 30 may engage dispensing mechanism 25 of aerosol paint container 22 to dispense the marking substance contained therein. Preferably, support member 20 and actuator 30 are both independently adjustably mounted with frame 10 such that the position of actuator 30 and support member 20 may be adjustable on frame 10 relative to surface 70 to produce marks having the desired requirements in accordance with the user's needs. Actuator 30 and support member 20 may be adjustably positioned on frame 10 at a predetermined distance from surface 70 such that a clear and distinct mark may be made thereon when actuator 30 engages dispensing mechanism 25 to cause aerosol paint container 22 to dispense paint. For example, actuator 30 and support member 20 may be adjustably positioned on frame 10 in a range between half an inch to six inches from surface 70 to engage dispensing mechanism 25 to produce a desired mark. Alternatively, actuator 30 may be operatively mounted on support member 20 such that actuator 30 may engage dispensing mechanism 25 of aerosol paint container 22 to dispense the marking substance contained therein.

In an embodiment of the invention, actuator 30 is comprised of an activator 32 and a power source 34. In accordance with an aspect of the present invention, when actuator 30 receives a signal from actuating means 40, as described in greater detail below, activator 32 is triggered to displace from a disengagement position to an engagement position such that activator 32 connects with dispensing mechanism 25, causing the spring-biased valve of aerosol paint container 22 to open to dispense the marking substance from aerosol paint container 22. In the absence of a signal from actuating means 40, activator 32 displaces from the engagement position to the disengagement position such that activator 32 disengages dispensing mechanism 25, causing the spring-biased valve to re-close, thereby terminating the dispensing of marking substance from aerosol paint container 22. In an embodiment of the invention, a motor connected to power source 34 causes activator 32 to displace between the engagement position and the disengagement position relative to dispensing mechanism 25. User may activate power source 34 when marking and measuring device 1 is properly zeroed to begin marking and measuring surface 70. Advantageously and unlike the prior art, the user is not required to manually trigger the dispensing of the marking substance from aerosol paint container 22. By simply causing marking and measuring device 1 to travel along surface 70, actuating means 40 sends a signal to actuator 30 at predetermined measurement intervals which automatically causes activator 32 to engage and disengage dispensing mechanism 25 as required such that surface 70 may be marked at desired predetermined measurement intervals.

Actuating means 40 is configured to be in communication with actuator 30 to activate and terminate the dispensing of the marking substance from aerosol paint container 22. Preferably, actuating means 40 is in electronic communication with actuator 30. Actuating means 40 may be comprised of a sensor 42 configured to contact, or otherwise engage or detect measurement mechanism 80, as described in greater detail below, such that actuating means 40 may send a signal to actuator 30 to dispense a marking substance at predetermined measurement intervals. Sensor 42 may be any type of sensor capable of responding to a stimulus such as but not limited to light, pressure, sound, motion, flow, or an electronic signal. Examples of sensor 42 include but are not limited to thermal, electromagnetic, electronic, mechanical, chemical, optical, or acoustic sensors.

In an embodiment of the invention, sensor 42 is a mechanical sensor such as a spring adapted to contact or otherwise cooperate with measurement mechanism 80 such that when sensor 42 detects a physical change in pressure or movement when sensor 42 contacts measurement mechanism 80, a signal may be generated and communicated to actuator 30 to dispense marking substance from aerosol paint container 22. When sensor 42 ceases contact with measurement mechanism 80, no signal is communicated to actuator 30 thereby terminating the dispensing of the marking substance from aerosol paint container 22. Alternatively, sensor 42 may be a photosensor that detects changes in light caused by measurement mechanism 80. As it will be appreciated by a person skilled in the art, there are a number of configurations by which sensor 42 may be triggered by measurement mechanism to activate actuator 30, and any of those can be used in the embodiments disclosed and claimed herein.

As best seen in FIGS. 1 to 3, first and second wheels 50, 60 are rotatably mounted to frame 10. Preferably, first wheel 50 is mounted with a front portion of frame 10 relative to the direction of travel A and second wheel 60 is mounted behind first wheel 50 and offset to one side of frame 10. First and second wheels 50, 60 mounted in such offset configuration thereby allows measuring and marking device 1 to move stably and evenly over surface 70 while accurately measuring surface 70. Advantageously, second wheel 60 is offset to one side of frame 10 such that second wheel 60 will not contact the fresh wet markings dispensed from aerosol paint container 22. Depending on the application of the marking and measuring device 1, first and second wheels 50, 60 may be the same or different diameters. Preferably, first wheel 50 is of a smaller diameter than second wheel 60.

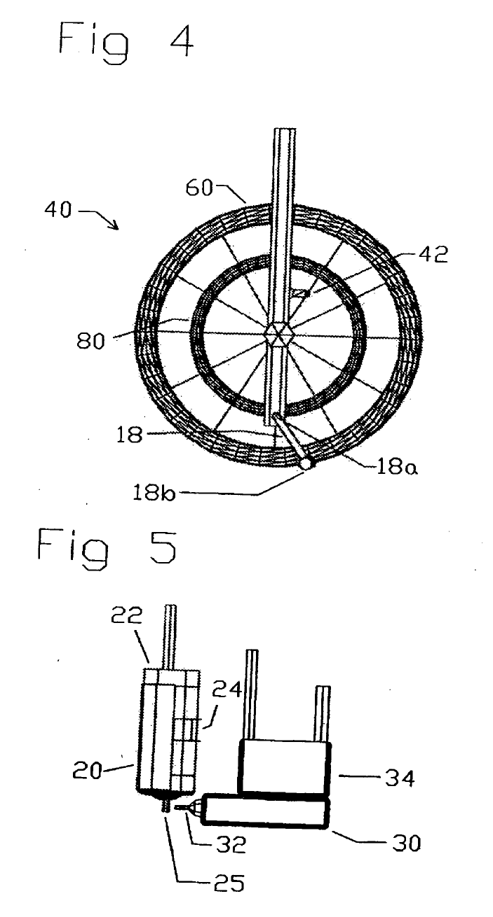

In an embodiment of the invention, measurement mechanism 80 may be a mechanism calibrated to provide sensor 42 with a stimulus to send a signal to actuator 30 at predetermined measurement intervals. In an embodiment of the invention, measurement mechanism 80 is a disc detachably and rotatably coupled with frame 10 such that measurement mechanism 80 rotates along with second wheel 60. As will be well appreciated by those skilled in the art, measurement mechanism 80 may rotate directly on surface 70 or may be rotated directly or indirectly by second wheel 60. As seen in FIG. 4, measurement mechanism 80 may be a disc having a plurality of projections 82a, 82b, 82c, 82d, 82e wherein measurement mechanism 80 is disposed between second wheel 60 and frame 10 and in close proximity with actuating means 40 such that sensor 42 may contact projections 82a, 82b, 82c, 82d, 82e. Disc 80 may be calibrated to provide sensor 42 with a stimulus to send a signal to actuator 30 at predetermined measurement intervals by the positioning of projections 82a, 82b, 82c, 82d, 82e. In other words, each of projections 82a, 82b, 82c, 82d, 82e may be configured to be positioned at a predetermined desired measurement apart relative to each other with uniform gaps. For example, disc 80 may be configured in a manner such that each of projections 82a, 82b, 82c, 82d, 82e are positioned sixteen inches apart and each time sensor 42 contacts each of projections 82a, 82b, 82c, 82d, 82e as disc 80 rotates, sensor 42 sends a signal to actuator 30 to dispense marking substance on surface 70 every sixteen inches. For greater clarity and by way of example, when the user moves marking and measuring device 1 relative to surface 70 in direction A, sensor 42 first contacts projection 82a and sends a signal to actuator 30 causing the marking substance to dispense from aerosol paint container 22. When sensor 42 ceases to contact projection 82a, the signal is terminated and the marking substance ceases to dispense. A first mark is thereby created on surface 70. As the user continues to be guide marking and measuring device 1 along surface 70 in direction A by causing first and second wheels 50, 60 to rotate, disc 80 also rotates causing sensor 42 to contact the next projection 82b. A signal is again sent to actuator 30 causing the marking substance to dispense from aerosol paint container 22 thereby creating a second marking on surface 70. A third, fourth, fifth, and sixth marking are similarly created on surface 70 as sensor 42 sequentially contacts projections 82c, 82d, 82e, 82a as disc 80 rotates. The user may continue to make any number of markings on surface 70 by guiding marking and measuring device 1 along surface 70. Because projections 82a, 82b, 82c, 82d, 82e are configured to be sixteen inches apart, each of first, second, third, fourth, fifth, sixth, and however many subsequent markings on surface 70 will necessarily be virtually sixteen inches apart. If the user desires markings to be created at a different predetermined measurement interval, disc 80 may be detached from frame 10 and a second disc 80 having a plurality of projections 82a, 82b, 82c, 82d, 82e calibrated at another predetermined measurement interval may be detachably and rotatably mounted with frame 10. Projections 82a, 82b, 82c, 82d, 82e may be calibrated to be positioned at virtually any predetermined measurement interval. Alternatively, measurement mechanism 80 may be a plurality of projections on second wheel 60 configured and calibrated in the same manner as described above. In the further alternative, measurement mechanism 80 may be second wheel 60 having a single projection to trigger sensor 42 when second wheel 60 has made a complete rotation. In such embodiment, the predetermined measurement interval is measured and determined by the circumference of second wheel 60.

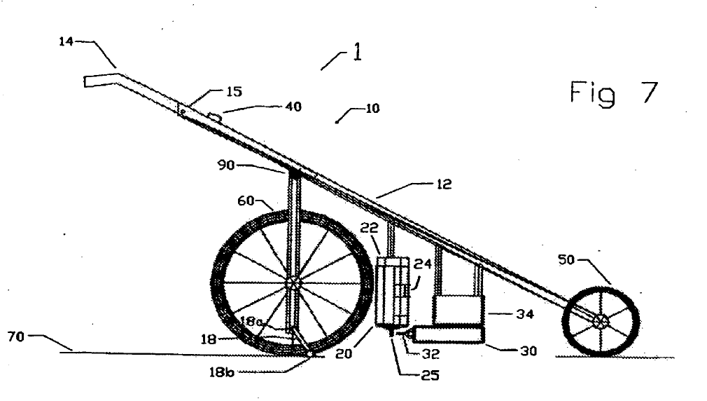

As seen in FIG. 7, in another embodiment of the invention, actuating means 40 is comprised of a controller 44 configured to compute the distance marking and measuring device 1 travels, in virtually any unit of measurement, when moved relative to surface 70 wherein controller 44 may be programmed to send a signal to actuator 30 at predetermined measurement intervals inputted by the user, as described in greater detail below. Controller 44 may be any device capable of determining distance traveled by marking and measuring device 1 relative to surface 70 such as but not limited to a counter mechanism. As it will be appreciated by a person skilled in the art, there are a number of counter mechanisms configured to count the number of revolutions of at least one rotatable wheel to determine the distance traveled, from simple mechanical counters to photosensors detecting light and opaque sections on a disk to encoder disks rotating between an emitter and a receiver, any of such counters may be used in the embodiments disclosed and claimed herein.

By way of example, controller 44 may be a microprocessor. The microprocessor may be programmed to know the circumference of at least one of first and second wheels 50, 60 such that the microprocessor may be configured to count the number of revolutions of at least one of first and second wheels 50, 60 to compute the distance marking and measuring device 1 has traveled when moved relative to surface 70. Similar to the mechanism described above, a sensor in cooperation with at least one of first and second wheels 50, 60 enables the processor to count the number of revolutions of at least one of first and second wheels 50, 60. Alternatively, processor may include a positional sensing mechanism configured to compute distance traveled by marking and measuring device 1 relative to at least one fixed starting point on surface 70 such as that used in global positioning systems.

Preferably, controller 44 also comprises of a numbered keypad for user to input the desired predetermined measurement interval such that controller 44 may send a signal to actuator 30 to produce a mark every time controller 44 measures the predetermined measurement interval when marking and measuring device 1 is moved relative to surface 70. For example, if a mark is desired at every ten inches along surface 70, the user may input such predetermined measurement interval into controller 44 to calibrate marking and measuring device 1 to produce a mark at such predetermined measurement interval. As marking and measuring device 1 is moved along surface 70, at every ten inch interval measured by controller 44, a signal may be sent to actuator 30 to commence and cease dispensing the marking substance from aerosol paint container 22. Controller 44 also preferably includes a reset switch which causes the processor to reset its counter mechanism to begin computing distance from zero. For example, when the user wants to begin a new measurement, the user may press the reset switch to clear the previously stored or measured data such that marking and measuring device 1 may be used to mark and measure surface 70 starting from zero. After the user presses the reset switch, the user may also enter a different predetermined measurement interval such that marking and measuring device 1 may measure and mark surface 70 according to the newly inputted predetermined measurement interval. In an embodiment of the invention, controller 44 further includes a conversion switch which allows the user to measure in metric, imperial or any other unit of measurement.

As seen in FIG. 7, controller 44 may be mounted with frame 10 at a lower end of handle 14. Preferably, controller 44 includes a display to allow the user to observe the distance traveled, the predetermined measurement interval inputted into the processor, and the number of desired marks produced on surface 70.

In an embodiment of the invention, at least one of support member 20, actuator 30, or second wheel 60 mounted with frame 10 may be pivotably mounted with body 12 such that frame 10 may collapse into a more compact form for transport. By way of example and as seen in FIG. 2, the portion of frame 10 that connects second wheel 60 with body 12 maybe pivotably attached to body 12 by way of a releasable fastener 90 such that when releasable fastener is released, such portion of frame 10 may pivot towards body 12 and secured in such position for compact storage or transport. Similarly, the portion of frame 10 that connects support member 20 and the portion of frame 10 that connects actuator 30 to body 12 may be similarly pivotably attached by way of releasable fastener 90. Releasable fastener 90 may be any fastener known in the art such as but not limited to pivot point fasteners, clevis pins, tension adjustment screws, and the like.

The foregoing description is made for purpose of illustration only and is not intended to limit the scope of the invention. From the foregoing, it should be clear that the present invention may be embodied in other forms other than those disclosed above, as will be appreciated by those skilled in the art, without departing from the spirit or essential characteristics of the invention. The above described embodiments are therefore to be considered in all respects illustrative and not restrictive.

I claim:

1. A marking and measuring device, said device comprising:
(a) a frame having a handle;
(b) a support member disposed on the frame configured to hold a container;
(c) an actuator mounted with said frame wherein said actuator is in communication with an actuating means mounted with said frame;
(d) at least two wheels rotatably coupled with said frame such that said at least two wheels rotate relative to a surface; and
(e) a measurement mechanism mounted with said frame in communication with said actuating means
wherein when said measurement mechanism sends a signal to said actuating means, said actuating means sends a signal to said actuator to cause a marking substance to dispense from said container and onto said surface.

2. The marking and measuring device of claim 1 further comprising a controller adapted to measure and communicate a measurement with said actuating means to cause said actuator to displace between a discharging position and a non-discharging position.

3. The marking and measuring device of claim 1 wherein said device is collapsible.

4. The marking and measuring device of claim 1 further comprising a stand pivotally coupled with said frame such that said stand may be displaced from a first closed position to a second open position such that said stand may support said measuring and marking device in a substantially upright position on said surface.

5. A marking and measuring device, said device comprising:
(a) a frame having a handle;
(b) a support member disposed on the frame configured to hold a container;
(c) an actuator mounted with said frame wherein said actuator is in communication with an actuating means mounted with said frame;
(f) at least two wheels rotatably coupled with said frame such that said at least two wheels rotate relative to a surface; and
(g) a controller mounted with said frame in communication with said actuating means
wherein said controller is adapted to measure and communicate a measurement with said actuating means; and
wherein when said controller communicates said measurement to said actuating means, said actuating means sends a signal to said actuator to displace between a discharging position and a non-discharging position to cause a marking substance to dispense from said container and onto said surface.
